(19) United States
(12) Patent Application Publication
(10) Pub. No.: US 2013/0173449 A1
(43) Pub. Date: Jul. 4, 2013

(54) SYSTEM AND METHOD FOR AUTOMATED DISPUTE RESOLUTION OF CREDIT DATA

(71) Applicant: TRANS UNION, LLC, Chicago, IL (US)

(72) Inventors: Po Cheung NG, Roseville (AU); Jeffrey Carson, Oak Lawn, IL (US); Douglas Thompson, Skokie, IL (US); Ronald Hagen, St. Paul, MN (US)

(73) Assignee: TRANS UNION, LLC, Chicago, IL (US)

(21) Appl. No.: 13/711,908

(22) Filed: Dec. 12, 2012

Related U.S. Application Data
(60) Provisional application No. 61/581,680, filed on Dec. 30, 2011.

(51) Int. Cl. G06Q 50/18

(52) U.S. Cl. CPC G06Q 50/182; G06Q 40/025
USPC 705/38

(57) ABSTRACT

A system and method for automated dispute resolution of credit data is provided. A consumer may receive a credit report from a credit bureau through a third party system. The consumer may submit a dispute including disputed credit data and corrections to the disputed credit data, if there is believed to be erroneous information in the credit report. An applicable member institution that supplied the disputed credit data may accept or reject the dispute. If the dispute is accepted, the current version of the disputed credit data may be retrieved and compared to the submitted disputed credit data. If the current and submitted versions of the disputed credit data match, then the disputed credit data may be updated with the corrections.

### CROSS-REFERENCE TO RELATED APPLICATION

This application claims priority to U.S. Provisional Application No. 61/581,680, filed Dec. 30, 2011, which is incorporated herein by reference in its entirety.

### TECHNICAL FIELD

This invention relates to a system and method for automated dispute resolution of credit data. More particularly, the invention provides a system and method for the automated processing of disputes involving disputed credit data in consumer credit reports.

### BACKGROUND OF THE INVENTION

The consumer lending industry bases its decisions to grant credit or make loans, or to give consumers preferred credit or loan terms, on the general principle of risk, i.e., risk of foreclosure. Credit and lending institutions typically avoid granting credit or loans to high risk consumers, or may grant credit or lending to such consumers at higher interest rates or other terms less favorable than those typically granted to consumers with low risk. Consumer data, including consumer credit information, is collected and used by credit bureaus, financial institutions, and other entities for assessing creditworthiness and aspects of a consumer's financial and credit history. Credit scores that are numerical approximations of risk associated with consumers may be generated based on a consumer's credit information and history. Credit scores may assist in assessing a consumer's credit.

Because credit information can play a large role in a consumer's ability to obtain and maintain credit, it is important for consumers to monitor the accuracy of their credit information. The consumer's activities can contribute to the data in the credit information. The activities of others, whether through fraud, through unknown but authorized use, or through clerical errors, may affect data in the credit information as well. If data in a consumer's credit information is incorrect and not timely corrected, it may significantly impair that consumer's ability to obtain credit or a loan. Correcting erroneous credit information manually may be a time-consuming process for the consumer, the credit bureau, and member institutions of the credit bureau.

Therefore, there is a need for a system and method that automates the dispute resolution process and the interaction between consumers, credit bureaus, and member institutions, in order to, among other things, allow consumers to submit disputes for correcting erroneous credit information.

### SUMMARY OF THE INVENTION

The invention is intended to solve the above-noted problems by providing systems and methods for automating the dispute resolution process and the interaction between consumers, credit bureaus, and member institutions. The systems and methods are designed to, among other things: (1) receive and validate consumer information and authenticate a consumer for generating a credit report from a credit bureau to the consumer through a third party system; (2) receive a dispute including disputed credit data and corrections to the disputed credit data from a consumer; (3) transmit the dispute to an applicable member institution; (4) receive an acceptance or rejection of the dispute from the applicable member institution; (5) correct the disputed credit data in the consumer's credit information, if the dispute is accepted and if the current version of the disputed credit data matches the disputed credit data submitted with the dispute; and (6) notify the applicable member institution, other member institutions, and the consumer of the correction to the disputed credit data.

In a particular embodiment, consumer information may be received and validated to provide a credit report to a consumer. The consumer information may be authenticated to ensure the consumer is authorized to access the credit report. The consumer information may initially be received by a third party system that is not a credit bureau. The third party system may transmit the consumer information to the credit bureau for validation and authentication of the consumer. The credit bureau may generate and transmit the credit report to the third party system for dispatch to the consumer.

In another embodiment, a dispute including disputed credit data and consumer corrections to the disputed credit data may be submitted and received from a consumer. The dispute may initially be received by a third party system that is not a credit bureau. The third party system may transmit the dispute and its associated data to the credit bureau for automated dispute resolution. The dispute may be transmitted to an applicable member institution, which may subsequently accept or reject the dispute and its associated consumer corrections to the disputed credit data. If the dispute is accepted by the applicable member institution, the current version of the disputed credit data may be retrieved. If the submitted disputed credit data matches the current version of the disputed credit data, then the disputed credit data may be corrected based on the submitted corrections. The applicable member institution, other member institutions, and the consumer may be notified of the corrections. If the submitted disputed credit data does not match the current version of the disputed credit data, or if the applicable member institution rejects the dispute, then no changes are made and the dispute resolution process is complete.

These and other embodiments, and various permutations and aspects, will become apparent and be more fully understood from the following detailed description and accompanying drawings, which set forth illustrative embodiments that are indicative of the various ways in which the principles of the invention may be employed.

### BRIEF DESCRIPTION OF THE DRAWINGS

FIG. 1 is a block diagram illustrating a system involving a third party system and a credit bureau for retrieving and transmitting a consumer credit report, and for automated dispute resolution of disputed credit data in a consumer's credit information.

FIG. 2 is a block diagram of one form of a computer or server of FIG. 1, having a memory element with a computer readable medium for implementing the system described in FIG. 1.

FIG. 3 is a flowchart illustrating operations for retrieving and transmitting a consumer credit report to a consumer through a third party system using the system of FIG. 1.

FIG. 4 is a flowchart illustrating operations for automated dispute resolution of disputed credit data in a consumer's credit information through a third party system, using the system of FIG. 1.

### DETAILED DESCRIPTION OF THE INVENTION

The description that follows describes, illustrates and exemplifies one or more particular embodiments of the invention in accordance with its principles. This description is not provided to limit the invention to the embodiments described herein, but rather to explain and teach the principles of the invention in such a way to enable one of ordinary skill in the art to understand these principles and, with that understanding, be able to apply them to practice not only the embodiments described herein, but also other embodiments that may come to mind in accordance with these principles. The scope of the invention is intended to cover all such embodiments that may fall within the scope of the appended claims, either literally or under the doctrine of equivalents.

It should be noted that in the description and drawings, like or substantially similar elements may be labeled with the same reference numerals. However, sometimes these elements may be labeled with differing numbers, such as, for example, in cases where such labeling facilitates a more clear description. Additionally, the drawings set forth herein are not necessarily drawn to scale, and in some instances proportions may have been exaggerated to more clearly depict certain features. Such labeling and drawing practices do not necessarily implicate an underlying substantive purpose. As stated above, the specification is intended to be taken as a whole and interpreted in accordance with the principles of the invention as taught herein and understood to one of ordinary skill in the art.

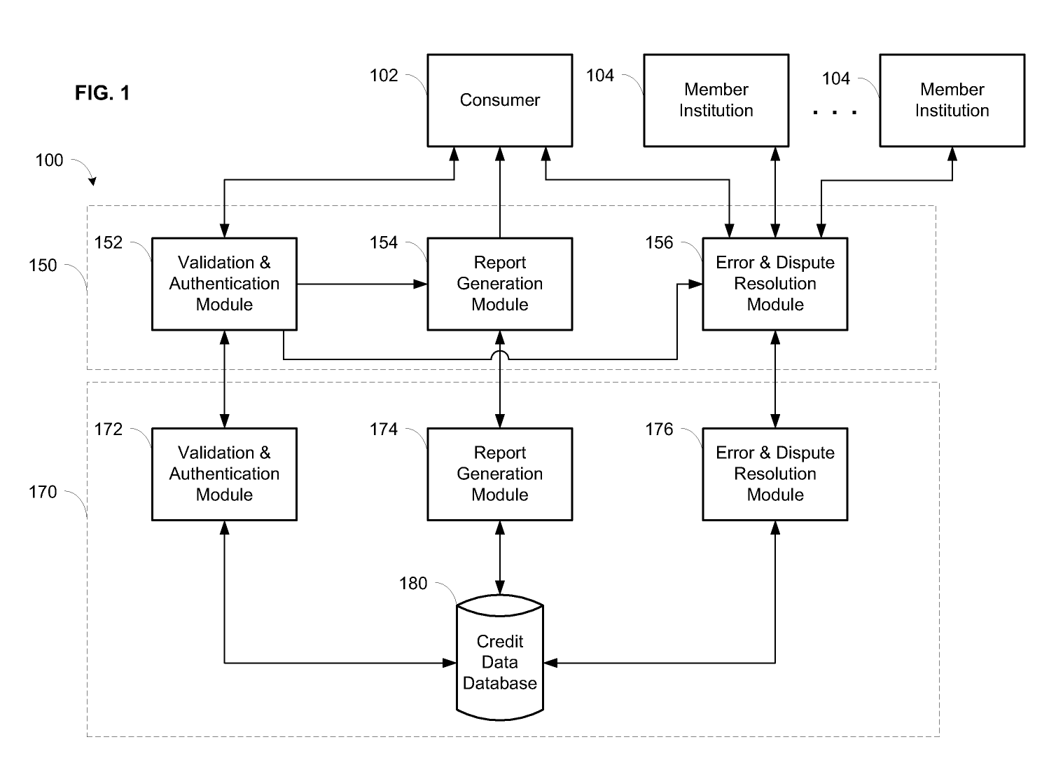

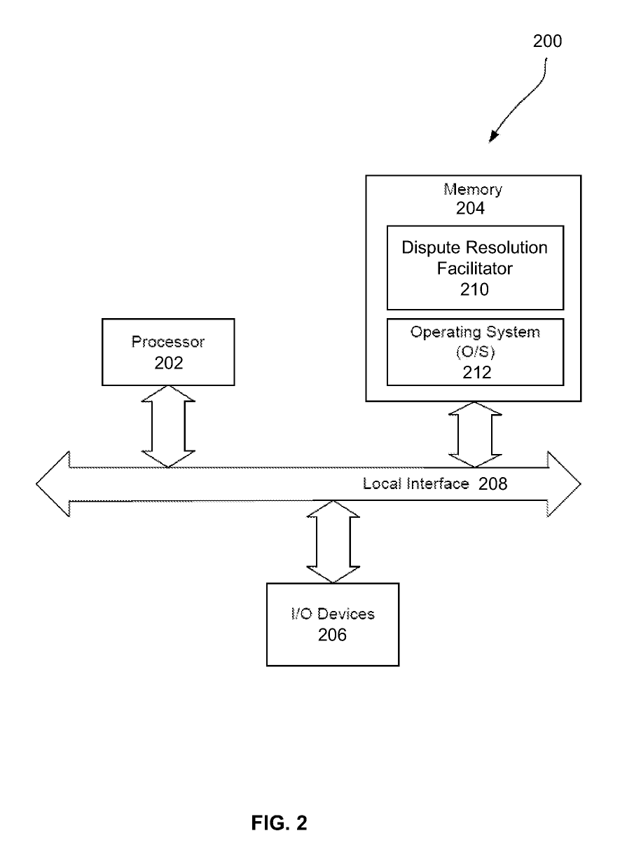

FIG. 1 illustrates a credit report retrieval and automated dispute resolution system 100 in accordance with one or more principles of the invention. The system 100 may include modules and components of a third party system 150 and a credit bureau 170. The system 100 may utilize consumer information from a consumer 102 to generate a credit report from a credit data database 180. The credit report may be transmitted to the consumer 102 by the credit bureau 170 through the third party system 150. The system 100 may also receive disputes including disputed credit data and corrections to the disputed credit data from the consumer 102 and perform automated dispute resolution. The automated dispute resolution process may include receiving an acceptance or rejection of the dispute from an applicable member institution that supplied the disputed credit data, such as a bank or other financial institution, and correcting the disputed credit data in the consumer's credit information, if the dispute is accepted. The disputed credit data may subsequently be corrected in a credit data database 180. Some components or all of the system 100 may be part of a larger system. For example, the third party system 150 may be the Consumer Relations System (CRS) of the Credit Information Bureau (India) Limited (CIBIL) system, and the credit bureau 170 may be the International Credit Reporting System (iCRS) from TransUnion. As another example, the third party system 150 may include other authorized consumer relations or direct-to-consumer systems. In some embodiments, the third party system 150 and the credit bureau 170 may be owned, operated, and/or controlled by the same entity. Various components of the system 100, including the third party system 150 and the credit bureau 170, may be implemented using software executable by one or more servers or computers, such as a computing device 200 with a processor 202 and memory 204 as shown in FIG. 2, which is described in more detail below.

A validation and authentication module 152 in the third party system 150 may validate consumer information received from a consumer 102 and authenticate the consumer 102 against credit data corresponding to the consumer 102, based on the validated consumer information. The module 152 may communicate with a validation and authentication module 172 in the credit bureau 170 to perform the validation of the consumer information and/or the authentication of the consumer. The consumer information received from the consumer 102 may be part of a request for a credit report or part of a dispute submission, and may include personal details such as, for example, name, gender, date of birth, identification number (e.g., passport number, Permanent Account Number (PAN), voter identification number, driver's license number, ration card number, universal ID number (Aadhaar), etc.), telephone numbers, addresses, email addresses, and/or other details. Some or all of the personal details may be mandatory in order to successfully process a consumer's request for a credit report or dispute submission. The consumer information may also include an Enquiry Control Number (ECN), Consumer Control Number (CCN), or other tracking identifier that identifies a previously retrieved credit report. The previously retrieved credit report can be specific to a particular transaction/enquiry and to a particular consumer involved with that particular transaction.

Validation of consumer information may include checking whether the data in the consumer information and/or the ECN/CCN is in an acceptable format. To perform the validation, the module 152 in the third party system 150 may call a validation service in the module 172 in the credit bureau 170 through a secure data exchange interface using, for example, the JavaScript Object Notation (JSON) standard. The data passed to the module 172 may include consumer information received from the consumer 102, e.g., personal details or ECN/CCN, as described above; a user identification and/or password of the third party system 150 for accessing the credit bureau 170; and/or a reference identifier for tracking purposes. The module 172 may return a notification to the module 152 that the consumer information is in an acceptable format, or indicate which data in the consumer information is invalid. If the consumer information is in an acceptable format, the module 152 may use the consumer information to construct a request to retrieve an indicative report with trade line summary data. The request may be in a TransUnion Enquiry Format (TUEF) or other format.

The indicative report may include personal information which can be used to authenticate the identity of the consumer 102, such as name, identification number, telephone number, address, etc. The information in the indicative report can be matched by the module 152 against the data in the consumer information submitted by the consumer 102. In some embodiments, the consumer 102 may contact the third party system 150 by telephone, email, etc. and communicate with an employee or agent of the third party system 150. In this case, multiple indicative reports may be retrieved so that the employee or agent can select the best fitting indicative report against the data in the consumer information submitted by the consumer 102.

To retrieve the indicative report, the module 152 may call an authentication service in the module 172 through a secure data exchange using, for example, the JSON standard. The data passed to the module 172 may include consumer information received from the consumer 102, e.g., personal details, as described above; a user identification and/or password of the third party system 150 for accessing the credit bureau 170; a flag to indicate whether the request is directly from the consumer 102 or via an employee or agent; and/or a reference identifier for tracking purposes. The module 172 may access the credit data database 180 and return the indicative report to the module 152 so that the module 152 can match the data in the consumer information to the data in the indicative report. The retrieval of the indicative report will not change any data in the credit data database 180. If the data in the indicative report matches the data in the received consumer information, the consumer 102 may be authenticated; otherwise the consumer 102 is not authenticated.

A report generation module 154 in the third party system 150 may generate a credit report, also known as a consumer disclosure report or credit information report, for transmittal to the consumer 102. For example, a credit information report typically lists financial institution names and account numbers, whereas a consumer disclosure report typically masks financial institution names and account numbers. The module 154 may call a report generation service in the report generation module 174 in the credit bureau 170 to generate the credit report. The call may be made through a secure data exchange interface using, for example, the JSON standard. The request passed to the module 174 may include a request including the consumer information received from the consumer 102, e.g., personal details, as described above; a user identification and/or password of the third party system 150 for accessing the credit bureau 170; and/or a reference identifier for tracking purposes. The module 174 may access the credit data database 180 and return the credit report to the module 154 for transmittal to the consumer 102. The credit report may include indicative information, enquiry information, employment information, the ECN/CCN identifier, trade line data, and/or other credit-related information. The ECN/CCN identifier may be stored in a database (not shown) of the third party system 150 for use during the automated dispute resolution process. In an embodiment where the consumer 102 has contacted the third party system 150 by telephone, email, etc., more than one credit report may be returned by the module 174 so that an employee or agent of the third party system 150 can select the best fitting credit report for the consumer 102.

An error and dispute resolution module 156 in the third party system 150 may provide automated dispute resolution for disputes including disputed credit data that is submitted and received from the consumer 102. The module 156 may call services in the error and dispute resolution module 176 in the credit bureau 170 to perform some or all of the functionality related to the automated dispute resolution process. The calls may be made through secure data exchange interfaces using, for example, the JSON standard. The consumer 102 may have already received their credit report through the validation and authentication module 152 and report generation module 154, as described above. If the consumer 102 believes data in their credit report is erroneous, the consumer 102 may submit a dispute including disputed credit data and consumer corrections to the disputed credit data to the module 156. The submitted dispute may also include an ECN/CCN from the consumer's credit report that uniquely identifies the previously retrieved credit report and its associated transaction.

The module 156 may verify the identity of the consumer 102 and that the submitted ECN/CCN is valid, prior to processing the disputed credit data. Verification of the ECN/CCN and the consumer's identity may be performed by the module 176 in the credit bureau 170 by passing the submitted ECN/CCN; a user identification and/or password of the third party system 150 for accessing the credit bureau 170; and/or a reference identifier for tracking purposes from the module 156 to the module 176. The module 176 may return the nature of the ECN/CCN (e.g., whether it exists, it is too old, whether it is related to a consumer disclosure report or a credit information report for banks, etc.); the date of the ECN/CCN; a file identification number (FID) that is a unique subject identifier; an enquiry purpose that defines the permissible purpose for which the enquiry was requested; response data that includes personal details from the credit data database 180; and/or other information. For an ECN/CCN to be valid, the ECN/CCN may be required to have been created within a certain time period to be valid, e.g., within the last 60 days. To verify the consumer's identity, the module 156 may match personal details in the response data against personal details that are entered by the consumer 102. If a majority of the personal details match and the ECN/CCN is valid, then the consumer 102 may proceed to submit the dispute including disputed credit data and corrections to the disputed credit data to the module 156.

The module 156 may call a service in the module 176 in the credit bureau 170 to retrieve full subject data for the consumer 102 so that the consumer 102 can see the most recent data in their credit information. The consumer 102 can be presented with the latest credit data against which an error can be raised so that if erroneous credit data has already been corrected, the consumer 102 does not need to submit a dispute. To retrieve the full subject data, the module 156 may pass the submitted ECN/CCN; a user identification and/or password of the third party system 150 for accessing the credit bureau 170; and/or a reference identifier for tracking purposes to the module 176. The module 176 may return subject data including name, identification numbers, telephone numbers, email addresses, addresses, account information, employment information, account numbers, account history information, remarks, and/or other information to the module 156. The module 156 may display this data to the consumer 102 so that the consumer 102 can submit a dispute that indicates the disputed credit data and includes corrections to the disputed credit data.

Once a dispute has been submitted to the module 156, an applicable member institution 104, such as a financial institution that is a member of the credit bureau 170, can accept or reject the dispute. The applicable member institution 104 may be the member institution that supplied the disputed credit data. If the applicable member institution 104 accepts the dispute, one or more error flags may be set for the disputed credit data. If the applicable member institution 104 rejects a dispute, an error flag for the disputed credit data would not be set. After the automated dispute resolution is completed, e.g., when a dispute is accepted and the disputed credit data is corrected, the error flag for the disputed credit data may be cleared.

The module 156 can call an error flagging service in the module 176 in the credit bureau 170 to set or clear an error flag for the disputed credit data in the credit data database 180. To set or clear the error flag on disputed credit data, the module 156 may pass an FID; serial numbers corresponding to the disputed credit data; an error code identifying the type of erroneous data; error remark codes; a service request number for auditing purposes; a user identification and/or password of the third party system 150 for accessing the credit bureau 170; and/or a reference identifier for tracking and purposes to the module 176. The module 176 may return a status indicating whether the error flag was successfully updated to the module 156. An error flag may not be successfully updated if the FID and/or the serial number do not exist for the consumer 102 in the credit data database 180. When an error flag is set for disputed credit data, the applicable records for the consumer 102 in the credit data database 180 may be frozen so that no further changes can be made on the disputed credit data until the automated dispute resolution process is completed. The applicable records may be unfrozen when the automated dispute resolution process is completed and the error flag is cleared.

The module 156 may receive an acceptance or rejection of the dispute from the applicable member institution 104. If the applicable member institution 104 accepts the dispute, then the corrections to the disputed credit data can be implemented by updating the applicable records for the consumer 102 in the credit data database 180. Prior to making the corrections, the modules 156 and 176 may retrieve the current version of the disputed credit data from the credit data database 180 to ensure that the submitted disputed credit data matches the current version of the disputed credit data and is therefore still synchronized. If the current version of the disputed credit data does not match the submitted disputed credit data, then the corrections would not be implemented because of the inconsistency. To retrieve the current version of the disputed credit data, the module 156 may pass an FID; the date of inquiry or the date when the last full subject data was pulled; a user identification and/or password of the third party system 150 for accessing the credit bureau 170; and/or a reference identifier for tracking and purposes to the module 176.

The module 176 may return the current version of the disputed credit data and serial numbers or FIDs corresponding to the disputed credit data to the module 156. The module 156 may then compare the current version of the disputed credit data with the submitted disputed credit data to check whether they are consistent. For example, the submitted dispute may include disputed credit data in a State A and consumer corrections to the disputed credit data to change the State A to a State B. However, after the dispute is accepted, if the current version of the disputed credit data has changed from the State A to a State C, then the corrections to the disputed credit data will not be implemented to the State B, because the current version of the disputed credit data is not the same as the submitted disputed credit data. In this case, it is possible that the disputed credit data had been corrected or may need different corrections.

If the current version of the disputed credit data matches the submitted disputed credit data, then the consumer corrections to the disputed credit data may be implemented on the applicable records for the consumer 102 in the credit data database 180. The module 156 may call a data update service in the module 176 in the credit bureau 170 to update the applicable records in the credit data database 180. For errors related to personal information, such as name and address, the submitted consumer corrections to the disputed credit data can be implemented to update the credit data database 180. For errors related to trade lines, although there may be consumer corrections to the disputed credit data, the applicable member institution 104 may ultimately determine the corrections to the disputed credit data that will be updated in the credit data database 180. In this case, the applicable member institution 104 may take the consumer corrections to the disputed credit data into account when determining the actual corrections to the disputed credit data.

To update the disputed credit data with corrections, the module 156 may pass an FID; serial numbers corresponding to the disputed credit data; a service request number for auditing purposes; current and new values of the disputed credit data; an error code identifying the type of erroneous data; a user identification and/or password of the third party system 150 for accessing the credit bureau 170; and/or a reference identifier for tracking and purposes to the module 176. The module 176 may return a status regarding whether the updates to the disputed credit data in the credit data database 180 were successful. If any of the updates to the disputed credit data fails, then no changes would be made to the applicable records in the credit data database 180. An update may fail, for example, if the FID and/or the serial number do not exist for the consumer 102 in the credit data database 180.

Following correction of the disputed credit data in the credit data database 180, the applicable member institution 104 and other member institutions 104 that are affected by the correction, if any, may be notified. The affected member institutions 104 may include those that have inquired about the consumer 102 in the certain past time period (sometimes referred to as a look back period), as defined by applicable laws. For example, the look back period may be 60 days, but may also be a time period between one and three months prior to the current date. The module 156 may call an inquiry data service in the module 176 in the credit bureau 170 to retrieve a list of the affected member institutions 104. The module 156 may pass an FID; a user identification and/or password of the third party system 150 for accessing the credit bureau 170; and/or a reference identifier for tracking and purposes to the module 176 to the module 176. The module 176 may return the list of affected member institutions 104. The module 156 may then transmit notifications of the corrections to the disputed credit data to the affected member institutions 104. The consumer 102 who initiated the dispute may also receive notification from the module 156 of the successful resolution of the dispute and the corrections to the disputed credit data.

Other secure data exchange interfaces may exist between the third party system 150 and the credit bureau 170 for supporting functionality and the exchange of data. A password change service may exist in the credit bureau 170 to allow a change of password for a particular user identification of the third party system 150. The third party system 150 may call the password change service in the credit bureau 170 and pass the user identification, the old password, the new password, and/or a reference identifier for tracking purposes. The credit bureau 170 may return a notification to the third party system 150 of the success or failure of the password change. An authentication service may also exist in the credit bureau 170 to allow authentication of member institutions 104 and/or the third party system 150 at the credit bureau 170. The member institution 104 and/or the third party system 150 may call the authentication service with the user identification, password, and/or a reference identifier for tracking purposes. The credit bureau 170 may return a notification of the success or failure of the authentication. The password change service and the authentication service may adhere to the Lightweight Directory Access Protocol (LDAP) or other standard.

FIG. 2 is a block diagram of a computing device 200 housing executable software used to facilitate the credit report retrieval and automated dispute resolution system 100. One or more instances of the computing device 200 may be utilized to implement any, some, or all of the components in the system 100. Computing device 200 includes a memory element 204. Memory element 204 may include a computer readable medium for implementing the system 100, and for implementing particular system transactions. Memory element 204 may also be utilized to implement the credit data database 180 and/or other databases. Computing device 200 also contains executable software, some of which may or may not be unique to the system 100. Where a portion of the system 100 is stored on the computing device 200, it is represented by, and is a component of, the dispute resolution facilitator 210. However, the dispute resolution facilitator 210 may also comprise other software to enable full functionality of the system 100, such as, for instance, a standard Internet browsing interface application.

In some embodiments, the system 100 and the facilitator 210 are implemented in software as an executable program, and is executed by one or more special or general purpose digital computer(s), such as a mainframe computer, a personal computer (desktop, laptop or otherwise), personal digital assistant, or other handheld computing device. Therefore, computing device 200 may be representative of any computer in which the system 100 and the facilitator 210 resides or partially resides.

Generally, in terms of hardware architecture as shown in FIG. 2, computing device 200 includes a processor 202, a memory 204, and one or more input and/or output (I/O) devices 206 (or peripherals) that are communicatively coupled via a local interface 208. Local interface 208 may be one or more buses or other wired or wireless connections, as is known in the art. Local interface 208 may have additional elements, which are omitted for simplicity, such as controllers, buffers (caches), drivers, transmitters, and receivers to facilitate external communications with other like or dissimilar computing devices. Further, local interface 208 may include address, control, and/or data connections to enable internal communications among the other computer components.

Processor 202 is a hardware device for executing software, particularly software stored in memory 204. Processor 202 can be any custom made or commercially available processor, such as, for example, a Core series or vPro processor made by Intel Corporation, or a Phenom, Athlon or Sempron processor made by Advanced Micro Devices, Inc. In the case where computing device 200 is a server, the processor may be, for example, a Xeon or Itanium processor from Intel, or an Opteron-series processor from Advanced Micro Devices, Inc. Processor 202 may also represent multiple parallel or distributed processors working in unison.

Memory 204 can include any one or a combination of volatile memory elements (e.g., random access memory (RAM, such as DRAM, SRAM, SDRAM, etc.)) and nonvolatile memory elements (e.g., ROM, hard drive, flash drive, CDROM, etc.). It may incorporate electronic, magnetic, optical, and/or other types of storage media. Memory 204 can have a distributed architecture where various components are situated remote from one another, but are still accessed by processor 202. These other components may reside on devices located elsewhere on a network or in a cloud arrangement.

The software in memory 204 may include one or more separate programs. The separate programs comprise ordered listings of executable instructions for implementing logical functions. In the example of FIG. 2, the software in memory 204 may include the system 100 and the facilitator 210, in accordance with the invention, and a suitable operating system (O/S) 212. Examples of suitable commercially available operating systems 212 are Windows operating systems available from Microsoft Corporation, Mac OS X available from Apple Computer, Inc., a Unix operating system from AT&T, or a Unix-derivative such as BSD or Linux. The operating system O/S 212 will depend on the type of computing device 200. For example, if the computing device 200 is a PDA or handheld computer, the operating system 212 may be iOS for operating certain devices from Apple Computer, Inc., PalmOS for devices from Palm Computing, Inc., Windows Phone 8 from Microsoft Corporation, Android from Google, Inc., or Symbian from Nokia Corporation. Operating system 212 essentially controls the execution of other computer programs, such as the system 100 and the facilitator 210, and provides scheduling, input-output control, file and data management, memory management, and communication control and related services.

If computing device 200 is an IBM PC compatible computer or the like, the software in memory 204 may further include a basic input output system (BIOS). The BIOS is a set of essential software routines that initialize and test hardware at startup, start operating system 212, and support the transfer of data among the hardware devices. The BIOS is stored in ROM so that the BIOS can be executed when computing device 200 is activated.

Steps and/or elements, and/or portions thereof of the invention may be implemented using a source program, executable program (object code), script, or any other entity comprising a set of instructions to be performed. Furthermore, the software embodying the invention can be written as (a) an object oriented programming language, which has classes of data and methods, or (b) a procedural programming language, which has routines, subroutines, and/or functions, for example but not limited to, C, C++, C#, Pascal, Basic, Fortran, Cobol, Perl, Java, Ada, and Lua. Components of the system 100 and the facilitator 210 may also be written in a proprietary language developed to interact with these known languages.

I/O device 206 may include input devices such as a keyboard, a mouse, a scanner, a microphone, a touch screen, a bar code reader, or an infra-red reader. It may also include output devices such as a printer, a video display, an audio speaker or headphone port or a projector. I/O device 206 may also comprise devices that communicate with inputs or outputs, such as a short-range transceiver (RFID, Bluetooth, etc.), a telephonic interface, a cellular communication port, a router, or other types of network communication equipment. I/O device 206 may be internal to computing device 200, or may be external and connected wirelessly or via connection cable, such as through a universal serial bus port.

When computing device 200 is in operation, processor 202 is configured to execute software stored within memory 204, to communicate data to and from memory 204, and to generally control operations of computing device 200 pursuant to the software. The system 100, the facilitator 210, and operating system 212, in whole or in part, may be read by processor 202, buffered within processor 202, and then executed.

In the context of this document, a “computer-readable medium” may be any means that can store, communicate, propagate, or transport data objects for use by or in connection with the system 100 and the facilitator 210. The computer readable medium may be for example, an electronic, magnetic, optical, electromagnetic, infrared, or semiconductor system, apparatus, device, propagation medium, or any other device with similar functionality. More specific examples (a non-exhaustive list) of the computer-readable medium would include the following: an electrical connection (electronic) having one or more wires, a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via, for instance, optical scanning of the paper or other medium, then compiled, interpreted or otherwise processed in a suitable manner if necessary, and stored in a computer memory. The system 100 and the facilitator 210 can be embodied in any type of computer-readable medium for use by or in connection with an instruction execution system or apparatus, such as a computer.

For purposes of connecting to other computing devices, computing device 200 is equipped with network communication equipment and circuitry. In a preferred embodiment, the network communication equipment includes a network card such as an Ethernet card, or a wireless connection card. In a preferred network environment, each of the plurality of computing devices 200 on the network is configured to use the Internet protocol suite (TCP/IP) to communicate with one another. It will be understood, however, that a variety of network protocols could also be employed, such as IEEE 802.11 Wi-Fi, address resolution protocol ARP, spanning-tree protocol STP, or fiber-distributed data interface FDDI. It will also be understood that while a preferred embodiment of the invention is for each computing device 200 to have a broadband or wireless connection to the Internet (such as DSL, Cable, Wireless, T-1, T-3, OC3 or satellite, etc.), the principles of the invention are also practicable with a dialup connection through a standard modem or other connection means. Wireless network connections are also contemplated, such as wireless Ethernet, satellite, infrared, radio frequency, Bluetooth, near field communication, and cellular networks.

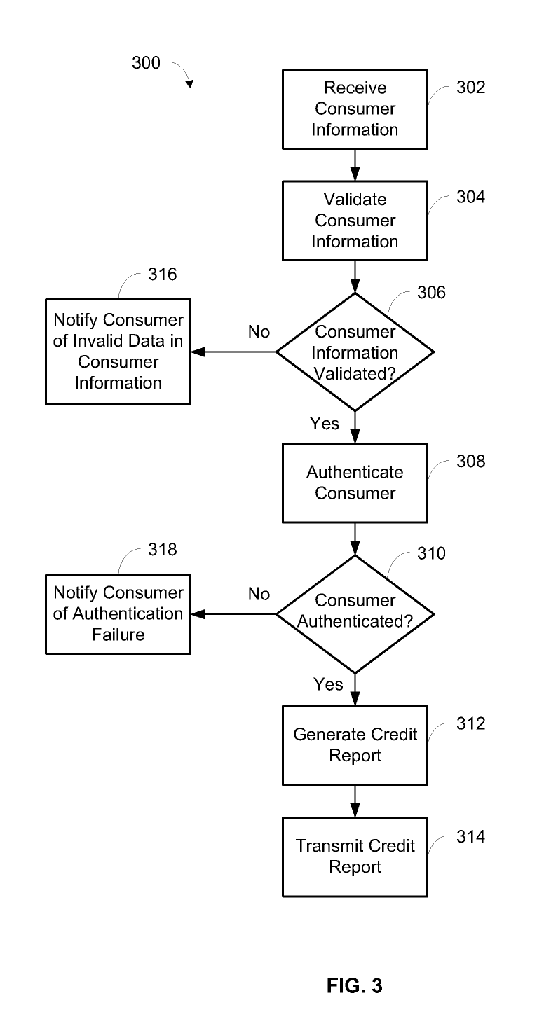

An embodiment of a process 300 for generating a consumer credit report for a consumer 102 through a third party system 150 is shown in FIG. 3. The process 300 can result in the generation and transmittal of a credit report to a consumer 102. The credit report may be obtained from a credit data database 180 based on submitted consumer information from the consumer 102. At step 302, consumer information may be received at the third party system 150 from the consumer 102, either directly or indirectly, such as when a consumer 102 contacts the third party system 150 through the telephone, email, etc. Personal details may be included in the consumer information, such as, for example, name, gender, date of birth, identification number (e.g., passport number, Permanent Account Number (PAN), voter identification number, driver's license number, ration card number, universal ID number (Aadhaar), etc.), telephone numbers, addresses, email addresses, and/or other details.

The consumer information may be received at a validation and authentication module 152 at step 302 so that the consumer information can be validated at step 304. Validating the consumer information may include checking whether the data in the consumer information is in an acceptable format. The module 152 may call a validation service in a validation and authentication module 172 in the credit bureau 170 to perform the validation of the consumer information at step 304.

If the consumer information is not valid at step 306, then the process 300 continues to step 316 and indicates which data in the consumer information is not valid, e.g., is not in an acceptable format. If the consumer information is valid at step 306, then the process 300 continues to step 308. At step 308, the consumer 102 may be authenticated by matching the submitted consumer information with data in a retrieved indicative report. The indicative report may be retrieved based on some or all of the submitted consumer information. To perform the authentication, the information in the indicative report can be matched by the module 152 against the data in the consumer information submitted by the consumer 102. The module 152 may call an authentication service in the module 172 in the credit bureau 170 to process the authentication of the consumer 102. If the consumer 102 is not authenticated at step 310, then the process 300 continues to step 318 and notifies the consumer 102 that the authentication has failed.

However, if the consumer 102 is authenticated at step 310, then the process 300 continues to step 312. At step 312, a credit report for the consumer 102 may be generated by the report generation modules 154 and 174. Payment from the consumer 102 may be required prior to generation of the credit report. The module 154 may call a report generation service in the report generation module 174 in the credit bureau 170 to generate the credit report. After generation of the credit report, the credit report may be transmitted to the consumer 102 by the module 154 at step 314.

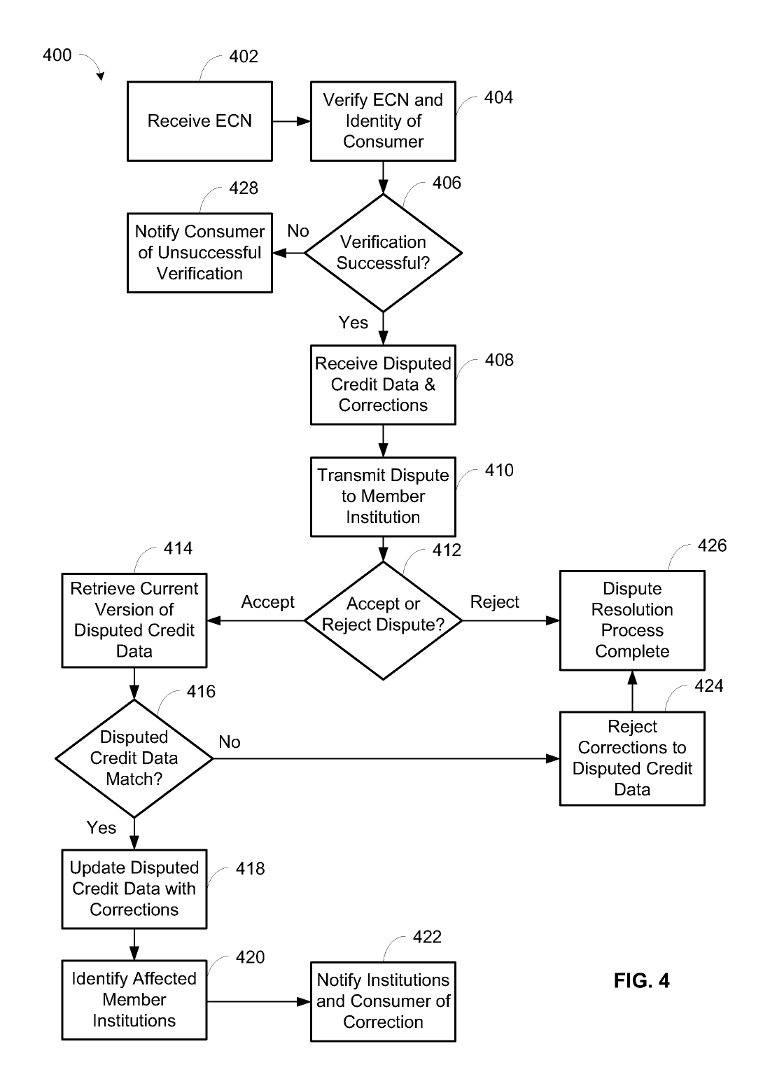

An embodiment of a process 400 for automated dispute resolution of disputes including disputed credit data in credit information of a consumer 102 is shown in FIG. 4. The process 400 can result in the automated dispute resolution of disputes that are submitted and received from the consumer 102. The consumer 102 may have received a credit report using the process 300 described above and may believe that there is data in their credit report that is erroneous. The dispute may be submitted by the consumer 102 including disputed credit data and consumer corrections to the disputed credit data. The submitted dispute may also include an ECN/CCN that is listed in the credit report that uniquely identifies the previously retrieved credit report and its associated transaction.

At step 402, the ECN/CCN may be received from the consumer 102 at the module 156 in the third party system 150. The ECN/CCN and the identity of the consumer 102 may be verified at step 404 by the module 156 by calling a verification service in the error and dispute resolution module 176 of the credit bureau 170. For the ECN/CCN to be valid, the ECN/CCN may be required to have been created within a certain time period to be valid, e.g., within the last 60 days. To verify the consumer's identity, the module 176 may return personal details from the credit data database 180 to the module 156 so that the module 156 can match the personal details to the consumer information submitted by the consumer 102. The identity of the consumer 102 may be verified if a majority of the personal details match. If the ECN/CCN is not valid and/or the identity of the consumer 102 is not verified at step 406, then the process 400 continues to step 428. At step 428, the module 156 may transmit a notification to the consumer 102 that the ECN/CCN is not valid and/or that the consumer 102 has not been successfully verified.

If the ECN/CCN is valid and the identity of the consumer 102 is verified at step 406, then the process 400 continues to step 408. At step 408, the module 156 may receive a dispute from the consumer 102 that includes disputed credit data and consumer corrections to the disputed credit data. The module 156 may retrieve full subject data for the consumer 102 so that the consumer 102 is presented with the latest credit data in their credit information against which to submit the dispute. The consumer 102 may then indicate which data in their credit information is the disputed credit data and also submit corrections to the disputed credit data at step 408.

The dispute may be transmitted from the module 156 to an applicable member institution 104 at step 410. The applicable member institution 104 may include a financial institution that is a member of the credit bureau 170, and may be the member institution that supplied the disputed credit data. The module 156 may receive an acceptance or rejection of the dispute from the applicable member institution 104 at step 412. The period of time between when the dispute is submitted and when the dispute is accepted or rejected may be any duration, e.g., several hours, days, etc., but there may be a maximum duration for when acceptance or rejection of the dispute must be received from the applicable member institution 104. The maximum duration for a response may be defined by applicable laws. For example, the maximum duration may be a time period between one and thirty days. If the dispute is rejected at step 412, then the process 400 continues to step 426 and the dispute resolution process is complete. In this case, the dispute is closed because the applicable member institution 104 is certifying that the disputed credit data is correct in their files since they are the owners and providers of that data. The consumer 102 may be notified by the module 156 that the dispute resolution process is complete and that the applicable member institution 104 has rejected the dispute. Another dispute may be opened by the consumer 102 if the consumer 102 believes that the applicable member institution 104 was incorrect in rejecting the original dispute.

However, if the dispute is accepted at step 412, then the process 400 continues to step 414. The applicable member institution 104 has agreed that the dispute is valid and that the disputed credit data is erroneous, if the dispute is accepted. An error flag may be set on the disputed credit data in the credit data database 180 when the dispute is accepted. The module 156 can call an error flagging service in the module 176 to set the error flag. In the case where the applicable member institution 104 does not respond to the dispute within the maximum duration for a response, a default action may be taken that is defined by applicable laws. For example, the default action may presume that the dispute is accepted at step 412, i.e., that the consumer is correct and that the disputed credit data is erroneous.

At step 414, the current version of the disputed credit data may be retrieved from the credit data database 180. The module 156 may call a retrieval service in the module 176 of the credit bureau 170 to retrieve the current version of the disputed credit data. The current version of the disputed credit data may be retrieved to ensure that the disputed credit data submitted with the dispute matches the current version of the disputed credit data and is therefore still synchronized. If the current version of the disputed credit data does not match the submitted disputed credit data at step 416, then the process 400 continues to step 424 where the corrections to the disputed credit data may be rejected. Following step 424, the dispute resolution process is complete at step 424. The consumer 102 may be notified by the module 156 that the dispute resolution process is complete and that the current version of the disputed credit data does not match the submitted disputed credit data. In addition, the error flag set on the disputed credit data in the credit data database 180 may be cleared.

However, if the current version of the disputed credit data matches the submitted disputed credit data at step 416, then the process 400 continues to step 418. At step 418, the disputed credit data in the credit data database 180 may be updated with the corrections to the disputed credit data. The module 156 may call a data update service in the module 176 to perform the updates to the disputed credit data. In addition, the error flag set on the disputed credit data may be cleared after the corrections to the disputed credit data have been applied. Other member institutions 104, if any, that are affected by the correction to the disputed credit data may be identified at step 420. The other member institutions 104 may include those that have inquired about the consumer 102 in the certain past time period, for example. The module 156 may call an inquiry data service in the module 176 to retrieve the list of affected member institutions 104. At step 422, the consumer 102 and the affected member institutions 104 (including the applicable member institution 104) may be notified of the completion of the corrections to the disputed credit data and that the dispute has been closed, e.g., that the dispute resolution process has been completed.

Any process descriptions or blocks in figures should be understood as representing modules, segments, or portions of code which include one or more executable instructions for implementing specific logical functions or steps in the process, and alternate implementations are included within the scope of the embodiments of the invention in which functions may be executed out of order from that shown or discussed, including substantially concurrently or in reverse order, depending on the functionality involved, as would be understood by those having ordinary skill in the art.

It should be emphasized that the above-described embodiments of the invention, particularly, any “preferred” embodiments, are possible examples of implementations, merely set forth for a clear understanding of the principles of the invention. Many variations and modifications may be made to the above-described embodiment(s) of the invention without substantially departing from the spirit and principles of the invention. All such modifications are intended to be included herein within the scope of this disclosure and the invention and protected by the following claims.

1. A method for managing corrections to credit data corresponding to a consumer, using a processor, the credit data stored in a credit data database of a credit bureau, the method comprising:
receiving at the processor an identifier that uniquely identifies the consumer;
verifying a validity of the identifier and an identity of the consumer, using the processor;
receiving a dispute resolution request at the processor, if the validity of the identifier and the identity of the consumer have been verified, wherein the dispute resolution request comprises disputed credit data and corrections to the disputed credit data, the credit data comprising the disputed credit data;
transmitting the dispute resolution request to an applicable member institution of the credit bureau, using the processor;
receiving at the processor a dispute response related to the dispute resolution request from the applicable member institution, wherein the dispute response comprises an acceptance of the dispute resolution request or a rejection of the dispute resolution request;
retrieving a current version of the disputed credit data from the credit data database, using the processor, if the dispute response comprises the acceptance of the dispute resolution request;
rejecting the corrections to the disputed credit data, using the processor, if the current version of the disputed credit data does not match the disputed credit data received with the dispute resolution request, or if the dispute response comprises the rejection of the dispute resolution request;
updating the disputed credit data in the credit data database with the corrections to the disputed credit data, using the processor, if the current version of the disputed credit data matches the disputed credit data received with the dispute resolution request;
identifying affected member institutions of the credit bureau, using the processor, the affected member institutions comprising one or more of the applicable member institution or a member institution of the credit bureau; and
transmitting an acceptance notification from the processor to the affected member institutions and to the consumer, wherein the acceptance notification comprises a notification that the disputed credit data has been updated with the corrections to the disputed credit data.

2. The method of claim 1, wherein verifying the validity of the identifier and the identity of the consumer comprises:
verifying that the identifier is valid, wherein the identifier is valid if the identifier was created within a predetermined past time period, using the processor;
retrieving, based on the identifier, an indicative report corresponding to the consumer from the credit data database, using the processor, wherein the indicative report comprises personal information for authenticating the identity of the consumer; and
determining whether the personal information in the indicative report matches personal information of the consumer, using the processor.

3. The method of claim 1, wherein receiving the dispute resolution request comprises:
retrieving the credit data corresponding to the consumer from the credit data database, using the processor, wherein the credit data comprises one or more of account information, account numbers, or account history information;
transmitting the credit data corresponding to the consumer from the processor; and
receiving at the processor an indication of the disputed credit data in the credit data and the corrections to the disputed credit data.

4. The method of claim 1, further comprising transmitting a rejection notification from the processor to the consumer, if the dispute response comprises the rejection of the dispute resolution request.

5. The method of claim 1, further comprising:
setting an error flag for the disputed credit data in the credit data database, using the processor, if the dispute response comprises the acceptance of the dispute resolution request; and
clearing the error flag for the disputed credit data in the credit data database, using the processor, in response to updating the disputed credit data in the credit data database with the corrections to the disputed credit data.

6. The method of claim 1, further comprising rejecting a second dispute resolution request received after receiving the dispute resolution request, using the processor, if the dispute response comprises the acceptance of the dispute resolution request, wherein the second dispute resolution request comprises the disputed credit data and second corrections to the disputed credit data.

7. The method of claim 1, wherein updating the disputed credit data comprises:
receiving at the processor member institution corrections to the disputed credit data; and
updating the disputed credit data in the credit data database with one or more of the member institution corrections to the disputed credit data or the corrections to the disputed credit data, using the processor.

8. The method of claim 1, wherein the affected member institutions comprise the member institution that has submitted an inquiry related to the consumer within a look back period.

9. The method of claim 1, wherein the identifier further uniquely identifies one or more of a credit report associated with the consumer, a transaction associated with the consumer, or an enquiry associated with the consumer.

10. The method of claim 1, wherein the identifier comprises one or more of an Enquiry Control Number (ECN) or a Consumer Control Number (CCN).

11. A system for managing corrections to credit data corresponding to a consumer, the credit data stored in a credit data database of a credit bureau, the system comprising:
a processor in communication with a network;
a memory in communication with the processor, the memory for storing:
the credit data database;
a validation and authentication module for:
receiving an identifier that uniquely identifies the consumer; and
verifying a validity of the identifier and an identity of the consumer; and
an error and dispute resolution module for:
receiving a dispute resolution request, if the validity of the identifier and the identity of the consumer have been verified, wherein the dispute resolution request comprises disputed credit data and corrections to the disputed credit data, the credit data comprising the disputed credit data;
transmitting the dispute resolution request to an applicable member institution of the credit bureau;
receiving a dispute response related to the dispute resolution request from the applicable member institution, wherein the dispute response comprises an acceptance of the dispute resolution request or a rejection of the dispute resolution request;
retrieving a current version of the disputed credit data from the credit data database, if the dispute response comprises the acceptance of the dispute resolution request;
rejecting the corrections to the disputed credit data, if the current version of the disputed credit data does not match the disputed credit data received with the dispute resolution request, or if the dispute response comprises the rejection of the dispute resolution request;
updating the disputed credit data in the credit data database with the corrections to the disputed credit data, if the current version of the disputed credit data matches the disputed credit data received with the dispute resolution request;
identifying affected member institutions of the credit bureau, the affected member institutions comprising one or more of the applicable member institution or a member institution of the credit bureau; and
transmitting an acceptance notification to the affected member institutions and to the consumer, wherein the acceptance notification comprises a notification that the disputed credit data has been updated with the corrections to the disputed credit data.

12. The system of claim 11, wherein the validation and authentication module verifies the validity of the identifier and the identity of the consumer by:
verifying that the identifier is valid, wherein the identifier is valid if the identifier was created within a predetermined past time period;
retrieving, based on the identifier, an indicative report corresponding to the consumer from the credit data database, wherein the indicative report comprises personal information for authenticating the identity of the consumer; and
determining whether the personal information in the indicative report matches personal information of the consumer.

13. The system of claim 11, wherein the error and dispute resolution module receives the dispute resolution request by:
retrieving the credit data corresponding to the consumer from the credit data database, wherein the credit data comprises one or more of account information, account numbers, or account history information;
transmitting the credit data corresponding to the consumer; and
receiving an indication of the disputed credit data in the credit data and the corrections to the disputed credit data.

14. The system of claim 11, wherein the error and dispute resolution module is further for transmitting a rejection notification to the consumer, if the dispute response comprises the rejection of the dispute resolution request.

15. The system of claim 11, wherein the error and dispute resolution module is further for:
setting an error flag for the disputed credit data in the credit data database, if the dispute response comprises the acceptance of the dispute resolution request; and
clearing the error flag for the disputed credit data in the credit data database, in response to updating the disputed credit data in the credit data database with the corrections to the disputed credit data.

16. The system of claim 11, wherein the error and dispute resolution module is further for rejecting a second dispute resolution request received after receiving the dispute resolution request, if the dispute response comprises the acceptance of the dispute resolution request, wherein the second dispute resolution request comprises the disputed credit data and second corrections to the disputed credit data.

17. The system of claim 11, wherein the error and dispute resolution module updates the disputed credit data by:
receiving member institution corrections to the disputed credit data; and
updating the disputed credit data in the credit data database with one or more of the member institution corrections to the disputed credit data or the corrections to the disputed credit data.

18. The system of claim 11, wherein the affected member institutions comprise the member institution that has submitted an inquiry related to the consumer within a look back period.

19. The system of claim 11, wherein the identifier further uniquely identifies one or more of a credit report associated with the consumer, a transaction associated with the consumer, or an enquiry associated with the consumer.

20. The system of claim 11, wherein the identifier comprises one or more of an Enquiry Control Number (ECN) or a Consumer Control Number (CCN).
